(19) United States
(12) Patent Application Publication
(10) Pub. No.: US 2026/0314622 A1
(43) Pub. Date: Oct. 15, 2026

(54) AN AERATION ASSEMBLY FOR LIPID ACTIVATION

(71) Applicant: SOCIETE DES PRODUITS NESTLE S.A., Vevey (CH)

(72) Inventors: Om Prakash SINGH, Patna, Bihar (IN); Rohit UPADHYAY, Faridabad, Haryana (IN)

(21) Appl. No.: 19/104,305

(22) PCT Filed: Aug. 14, 2023
(86) PCT No.: PCT/EP2023/072377

§ 371 Date: Feb. 17, 2025

(30) Foreign Application Priority Data
Aug. 31, 2022 (IN) 202211049843
Oct. 18, 2022 (EP) 22202171.9

(51) Int. Cl. A23D 9/04; A23L 27/00; B01D 53/00; B01F 23/231; B01F 23/233; B01F 35/00; B01F 35/90; B01F 35/92

(52) U.S. Cl. CPC A23D 9/04; A23L 27/70; B01D 53/002; B01F 23/23113; B01F 23/23354; B01F 23/23362; B01F 35/189; B01F 35/92; B01F 2035/99

(57) ABSTRACT

In an embodiment to the present invention an aeration assembly (100) is disclosed. The aeration assembly (100) includes an aeration tank (102) with a closed top (110) and a curved base (112) to house a lipid to be aerated. The aeration tank (102) includes an inlet conduit (302) to allow passage of air for aeration of the lipid, a ring conduit (304) arranged along inner circumference of bottom of the aeration tank (102), a micronization assembly (306) having spargers (310) to receive air from the ring conduit (304) for micronization. Further, a propeller type impeller (308) arranged agitates the lipid in the aeration tank (102) to facilitate contact between the micronized air and the lipid for aeration of the lipid to obtain aerated lipid and by-products of aeration.

### FIELD OF THE INVENTION

The present invention generally relates to an aeration assembly. In particular, the present invention relates to an aeration assembly for lipid activation.

### BACKGROUND OF THE INVENTION

Generally, lipids are used as flavor carrier in food processing industry for delivering desired flavor profile of food in addition to being used for texturization, and as a source of essential fatty acids. For example, oil is used in non-fried instant noodles to deliver flavor profile of fried noodles. Desired flavors are generated by appropriate reaction with the lipids amounting to modulation of the lipids to increase their flavor potential and then the lipids with the generated flavor are added to raw materials of food products, so that the cooked food delivers desired flavor profile. However, the quantity of lipids used to enable the food product to deliver the desired flavor profile is unhealthy for the consumer of the food. On the other hand, addition of insufficient amount of lipid leads to dilution of the flavor profile delivered by the food product. Accordingly, the quantity of lipids needs to be balanced to prevent any excess fat that imbalances not only the taste but also the nutritional profile of the food.

Thus, in the light of the above, there is a need for a mechanism to extract lipid with the generated flavors, such that the flavor potential of the lipids may be maximized. Such lipids may be used in various applications, like culinary application, so that upon addition of the generated flavor to a food product, the food product may deliver desired flavor profile without use of excessive amount of lipid.

### SUMMARY OF THE INVENTION

In an embodiment to the present invention an aeration assembly is disclosed. The aeration assembly includes an aeration tank with a closed top and a curved base to house a lipid to be aerated. The aeration tank includes an inlet conduit to allow passage of air for aeration of the lipid to a ring conduit in the aeration tank and the ring conduit arranged along inner circumference of bottom of the aeration tank. The aeration tank further includes a micronization assembly including one or more spargers and radially attached to the ring conduit to receive air from the ring conduit and micronize the received air by passing the received air through the one or more spargers. Further, a propeller type impeller arranged axially above the sparger assembly to agitate the lipid in the aeration tank to facilitate contact between the micronized air and the lipid for aeration of the lipid to obtain aerated lipid and by-products of aeration. Size of the micronized air bubble is less than 50 to 100 microns. The aerated lipid has a Total Polar Matter (TPM) in range of 6.5-20%, preferably in range of 12-15%.

In an embodiment of the present invention, the aeration assembly further includes an air supply device. The air supply device is configured to receive atmospheric air pulled in by a centrifugal blower, receive compressed air from a compressed air source, combine the received atmospheric air with the received compressed air to control pressure and rate of flow of the air and pass the combined air to the inlet conduit of the aeration tank for aeration of the lipid in the aeration tank.

In an embodiment of the present invention, the aeration assembly further includes a temperature control device that includes one or more temperature sensors and a heating element. The one or more temperature sensors are configured to monitor the temperature of the lipid in the aeration tank and the heating element is configured to vary the temperature of the lipid in the aeration tank based on the temperature sensed by the one or more temperature sensors.

The one or more temperature sensors are arranged inside the aeration tank and the heating element is attached to the outer circumference of the aeration tank, such that heat from the heating element is transferred to the lipid by conduction of heat through the walls of the aeration tank.

In an embodiment of the present invention, the aeration assembly further includes an exhaust device configured to expel the by-products obtained along with aerated lipid. The exhaust device has a condenser column vertically attached above the aeration tank to receive gaseous by-products after aeration of the lipid to condense them before expelling out of the aeration assembly. Further, a horizontal heat exchanger coupled to the condenser to further condense the gaseous by-products and reduce the temperature of the gaseous by-products received from the condenser column. Also, a gaseous exhaust outlet coupled to the horizontal heat exchanger to vent out gaseous by-products. Further, a scrubber apparatus coupled to the horizontal heat exchanger to receive the condensed by-products for treatment, such that the condensed by-products treated by the scrubber apparatus are neutralized before expelling from the aeration assembly.

In an embodiment of the present invention, the scrubber apparatus is a water scrubbing apparatus.

In an embodiment of the present invention, the aeration of the lipid occurs at a temperature between 100-180 degree centigrade (C) for an aeration time between 2 to 10 hours.

In an embodiment of the present invention, the aeration of the lipid occurs at a flow rate of air in a range of 0.5-8 Litres per hour per gram, more preferably between 4 to 8 Litres per hour per gram of lipid (L/h/g) for an aeration time between 2 to 10 hours.

In an embodiment of the present invention, the aeration assembly further includes a collection device arranged at the bottom of the aeration tank having a collection conduit and a collection valve to collect the aerated lipid from the aeration tank.

Other aspects, advantages, and salient features of the present invention will become apparent to those skilled in the art from the following detailed description read in conjunction with the drawings.

### BRIEF DESCRIPTION OF DRAWINGS

The following drawings are illustrative of preferred embodiments for enabling the present invention and are not intended to limit the scope of the invention. The drawings are not to scale (unless so stated) and are intended for use in conjunction with the explanations in the following detailed description.

FIGS. 1(a), 1(b) and 1(c) illustrate different views of an aeration assembly in accordance with an embodiment of the present invention;

FIG. 2(a) illustrates a top view of the aeration assembly with closed top in accordance with an embodiment of the present invention;

FIG. 2(b) illustrates another top view of the aeration assembly with open top in accordance with an embodiment of the present invention; and

FIG. 3 illustrates isometric view of an inlet conduit, a ring conduit, a micronization assembly and a propeller type impeller in the aeration tank in accordance with an embodiment of the present invention.

### DETAILED DESCRIPTION OF DRAWINGS

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For the purpose of clarity, details relating to technical material that is known in the technical fields related to the invention have not been described in detail so as not to unnecessarily obscure the present invention.

The present invention relates to generation of fatty and fried flavors by activation of lipids. The lipids are activated by exposing them to predefined temperature for a predefined period of time in an aeration assembly, configured to activate lipids, disclosed in subsequent sections of the present description. Accordingly, the activation of lipids may be understood as thermo-oxidative treatment of lipids to accelerate controlled lipid oxidation to accomplish the desired intensity of oxidation marker and in process generation of fatty and fried flavors in the lipid. The generated fatty and fried flavors may then be used in food processing by addition of the lipid with the flavors to deliver desired flavor profile. For example, the activated lipid may be used for processing instant food items, such as instant non-fried noodles to deliver desired fatty and fried flavor profile.

In the present invention, the oxidation marker that has been used as an end-point indicator of lipid activation process is Total Polar Matter (TPM). The TPM is typically considered as a discard indicator for frying lipids. It may be known to a person of ordinary skilled in the art that oxidation of lipid during high temperature processes increases the TPM of the lipid. Generally, the most optimal range of TPM where marker compound(s) are adequately produced to exhibit fried characteristic in lipid is 12-15%. Further, when TPM goes beyond 15%, perceivable rancidity starts to set-in in the lipid due to generation of excess of short chain aliphatic aldehydes like hexanal which contribute to rancid like notes and thus, amounting to degradation of the lipid. The desired TPM in range of 12-15% has been achieved by the present invention due to the configuration of the aeration assembly and the operating conditions for the activation of the lipid via oxidation within the aeration assembly.

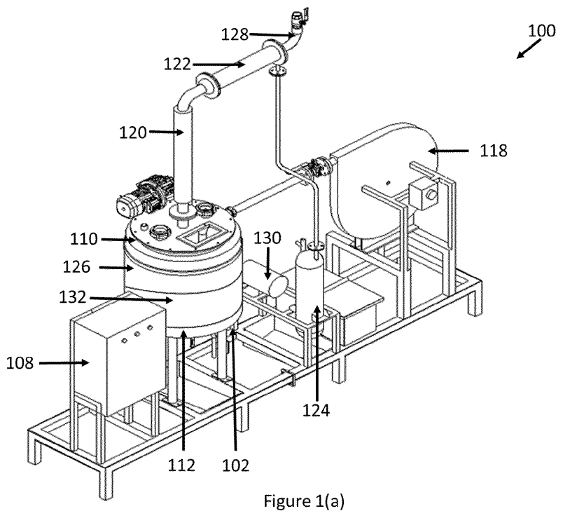

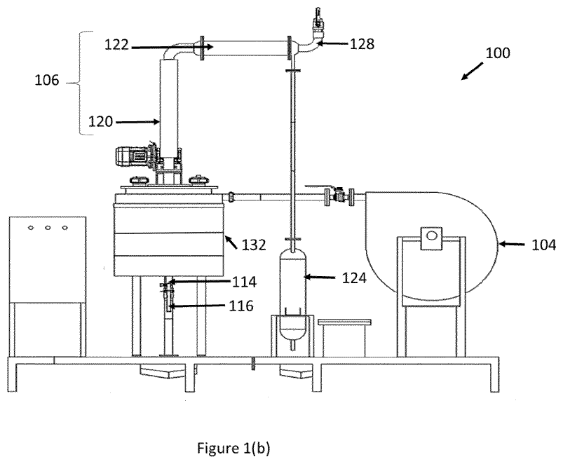

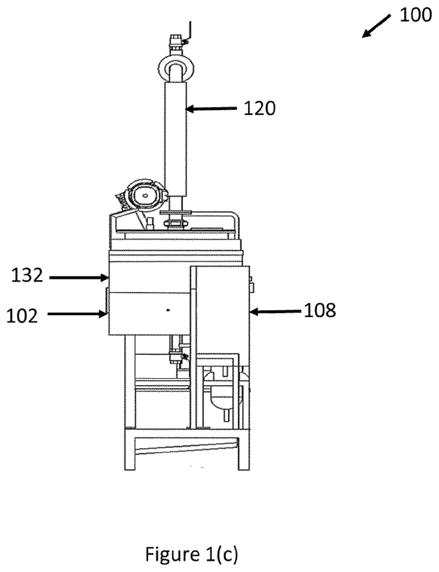

FIGS. 1(a), 1(b) and 1(c) illustrate different views of an aeration assembly 100 in accordance with an embodiment of the present invention. FIG. 1(a) illustrates an isometric view of an aeration assembly 100. FIG. 1(b) illustrates another isometric view of the aeration assembly 100. Furthermore, FIG. 1(c) illustrates a side view of the aeration assembly 100. For the sake of brevity FIGS. 1(a), 1(b) and 1(c) are described together.

In an embodiment of the present invention, the aeration assembly 100 is configured to activate lipid by subjecting the lipid in the aeration assembly 100 to a thermo-oxidative treatment. The activated lipid may be used as a flavor carrier in food processing industry. The activation of the lipid may act as a high-density carrier of flavor and therefore, limited amount of activated lipid may be added to raw material of food product to enable the food product to deliver flavor profile equivalent to relatively higher amount of non-activated lipid. Upon desired aeration of the lipid, activated lipid with flavor markers may be generated. These are lipid derived flavor reaction intermediates or fried marker compounds collectively called as α, β-unsaturated aldehydes. In the present invention, the flavor modulation of lipid has been optimized to produce higher intensity of fried marker compounds which are classified as α, β-unsaturated aldehydes like (E, E)-2, 4-decadienal.

The aeration assembly 100 may include an aeration tank 102, an air supply device 104, an exhaust device 106 and a control unit 108. The various components of the aeration assembly 100, such as the aeration tank 102, the air supply device 104, the exhaust device 106 and the control unit 108 may be arranged on a unified frame in a premise. In another embodiment of the present invention, the various components of the aeration assembly 100 may be arranged on a distributed frame in the premise.

The aeration tank 102 may house the lipid to be activated via aeration. The air supply device 104 may be connected to the aeration tank on an upper end of a vertical cylindrical wall 126 of the aeration tank 102. The air supply device 104 may provide air at predefined flow rate to aerate the lipid in the aeration tank 102. Further, the exhaust device 106 may be attached to top of the aeration tank 102. The exhaust device 106 may be configured to suck-in by-products of activation of the lipid in the aeration tank 102, neutralize them and expel them out of the aeration assembly 100. Further, the activated lipid with the flavor may be collected from the aeration tank 102.

The control unit 108 may be communicatively linked to one or more sensors on surface of and inside the aeration tank 102, the air supply device 104 and the exhaust device 106. The control unit 108 may be configured to control operation of the aeration tank 102, the air supply device 104 and the exhaust device 106, to provide requisite operating conditions for activation of lipid via aeration in the aeration tank 102.

Further, the aeration tank 102 may be configured to house the lipid to be activated via aeration. The aeration tank 102 may be a cylindrical container with cylindrical wall 126, a closed top 110 and a curved base 112. In an embodiment of the present invention, the aeration tank 102 may have a polygonal shape. Further, the curved base 112 may have a U-trough shape. The aeration tank 102 may also include an inlet conduit, a ring conduit, a micronization assembly and a propeller type impeller. In an embodiment of the present invention, a collection device may be arranged at the bottom of the aeration tank 102 having a collection conduit 114 and a collection valve 116 to collect the aerated lipid from the aeration tank 102.

The curved base 112 of the aeration tank 102 enables creation of desired vortex while mixing the air from micronization assembly with the lipid to uniformly aerate the lipid. Further, the curved base 112 also enables faster and efficient collection of the aerated lipid through the collection device.

In a trial configuration of the aeration tank 102, the base was kept flat not curved. It was observed that flat base of the aeration tank 102 did not provide any support for the creation of the vortex. As a result, at specific locations of the aeration tank 102, such as immediately close to the micronization assembly the aeration of the lipid was higher than at the peripheral spots near circumference of the aeration tank 102. Thus, non-uniform aeration and activation of the lipid occurred in flat base aeration tank 102 as compared to the curved base 112 aeration tank 102.

The air supply device 104 may be configured to supply air to the aeration tank 102 at a predefined pressure to aerate the lipid for the activation of the lipid via the inlet conduit. In an exemplary embodiment of the present invention, the predefined pressure may be in range of 600-900 mm Hg or 0.8-1.2 Bar-g of water column. In an embodiment of the present invention, the air supply device 104 may be coupled to a centrifugal blower 118 and a compressed air source to receive the air for supplying to the aeration tank 102. The air supply device 104 may include a pressure control valve to control pressure of air supplied to the inlet conduit.

In an embodiment of the present invention, the air supply device 104 may be configured to receive atmospheric air pulled in by the centrifugal blower 118 and receive compressed atmospheric air from the compressed air source. In an embodiment of the present invention, impeller in the centrifugal blower 118 may be made of Stainless Steel (SS) 304, SS 316, or aluminium. It may be understood that the impeller made of aluminium may be lighter than the impeller made of SS 304 or SS 316, amounting to reduction in weight of the complete aeration assembly 100.

Further, the air supply device 104 may also be configured to combine the received atmospheric air with the received compressed air to control pressure and rate of flow of the air in the aeration tank 102. In an exemplary embodiment of the present invention, the pressure control valve of the air supply device 104 may have different operating states to control pressure and rate of flow of the air. Next, the combined air may be passed to the inlet conduit of the aeration tank 102 for aeration of the lipid in the aeration tank 102.

It may be understood that for the aeration of lipid, a high volume of air is required which is approximately 0.5 to 8 Liters per hour per gram of lipid, more preferably 4 to 8 Liters per hour per gram of lipid. The high volume of air may be supplied using the centrifugal blower 118 designed for suitable back pressure to allow the air to diffuse as micronized bubbles from the micronization assembly. However, with the continued interaction of lipid and air over a period of time more than 60 mins, the physical properties of the lipid tends to change resulting in fine layer depositions over a surface of the micronization assembly. The fine layer depositions tend to limit efficacy of the aeration assembly 100 and subsequently activation of the lipid. To overcome the challenge of depositions and enhance the system efficiency, the compressed air source may be used, such that the higher pressure may remove the fine layer depositions. In an exemplary embodiment of the present invention, the compressed air may be used in an intermittent or continuous mode. In an exemplary embodiment of the present invention, the flow of the compressed air may be controlled through a set of pneumatically operated solenoid valves. Further, the higher pressure may be in range of 1.5-2.5 bar-g.

In an exemplary embodiment of the present invention, the atmospheric air may be pulled in by the centrifugal blower 118 through a HEPA 5 filter attached at a suction inlet of the centrifugal blower 118. Further, the compressed air may be passed through a series of filtration units, as per food industry standards, followed by a filter-regulator unit. In an embodiment of the present invention, the compressed air source may be oil free compressor units.

In an embodiment of the present invention, the exhaust device 106 may be configured to neutralize and reduce temperature of by-products obtained along with the aerated lipid before expelling them out of the aeration assembly 100. In an embodiment of the present invention, the exhaust device 106 may include a condenser column 120, a horizontal heat exchanger 122 and a scrubber apparatus 124.

The condenser column 120 may be vertically attached above the aeration tank 102 to receive gaseous by-products after aeration of the lipid to condense them before expelling out of the aeration assembly 100.

The horizontal heat exchanger 122 may be coupled to the condenser column 120 to further condense the gaseous by-products and reduce the temperature of the gaseous by-products received from the condenser column 120. Further, a gaseous exhaust outlet 128 of the exhaust device 106 may be coupled to the horizontal heat exchanger 122 to vent out gaseous by-products.

The scrubber apparatus 124 of the exhaust device 106 may be coupled to the horizontal heat exchanger 122 to receive the condensed by-products for treatment. The condensed by-products may be treated by the scrubber apparatus 124 to neutralized them before expelling from the aeration assembly 100. In an embodiment of the present invention, the scrubber apparatus 124 may be a water scrubbing apparatus. In another embodiment of the present invention, the scrubbing apparatus may be a chemical scrubbing apparatus where the selected chemicals would interact with the particulate matter of exhaust fumes in the by-product. In case of the chemical scrubbing apparatus, the exhaust fumes may be treated through an activated charcoal assembly to address the pungent smell. In yet another embodiment of the present invention, the scrubbing apparatus may be a wet scrubbing apparatus implementing limestone for the neutralization of the by-products.

To achieve the present configuration of the aeration assembly 100 various trial were conducted. With stepped and sequential improvement on the lipid and air interactions to generate flavor markers, challenges were faced on the moisture coming out and strong pungent smell in the operating area of the aeration assembly 100. The present configuration with closed aeration tank 102 with a U bend or the curved base 112 to act as a breather and allow the venting of moisture.

As the by-products or the fumes in exhaust device 106 may also contains minute lipid particles they tend to have the strong pungent smell and cause irritation to the eyes. Thus, to address the issues associated with the by-products present configuration of the exhaust device 106 was worked out. In the present configuration, the fumes exhausted may be passed through a water column and heat exchanger set-up to condense the vapors of moisture and oil by using water circulation, optionally with chilled water at 10-12° C. as the temperature of the fumes may be in the range of 120-180° C. and more.

Further, even after condensation by the condenser column 120 and temperature reduction via the horizontal heat exchanger 122, the by-products may still have the pungent smell and still cause irritation to eyes is vented out as it is. Accordingly, the cooled down by-product may be passed through the water scrubber apparatus 124, such that a vacuum pump 130 associated with the scrubber apparatus 124 may suck the remaining by-products for treatment by the scrubber apparatus 124. The treatment by the scrubber apparatus 124 facilitates an operator to operate the aeration assembly 100 continuously for longer time durations without damages to the health of the operator.

The control unit 108 may be configured to control the operation of the aeration assembly 100. In an embodiment of the present invention, the control unit 108 may be associated with plurality of sensors and one or more microcontrollers. The sensors may, without any limitation, be pressure sensors, temperature sensors and flow rate sensors.

The control unit 108 may include a temperature control device that includes one or more temperature sensors and a heating element 132. The one or more temperature sensors may be configured to monitor the temperature of the lipid in the aeration tank 102 and the heating element 132 may be configured to vary the temperature of the lipid in the aeration tank 102 based on the temperature sensed by the one or more temperature sensors.

In an embodiment of the present invention, the one or more temperature sensors may be arranged inside the aeration tank 102 with direct contact to the lipid. In another embodiment of the present invention, the one or more sensors may be arranged outside the aeration tank 102, on the aeration tank body, such as on lid 202 and cylindrical wall 126. Further, the heating element 132 may be attached to the outer circumference of the aeration tank 102, such that heat from the heating element 132 is transferred to the lipid by conduction of heat through the walls of the aeration tank 102 amounting to indirect heating of the lipid for uniformity of heating and creating uniform temperature throughout the aeration tank 102 for homogenous aeration of the lipid.

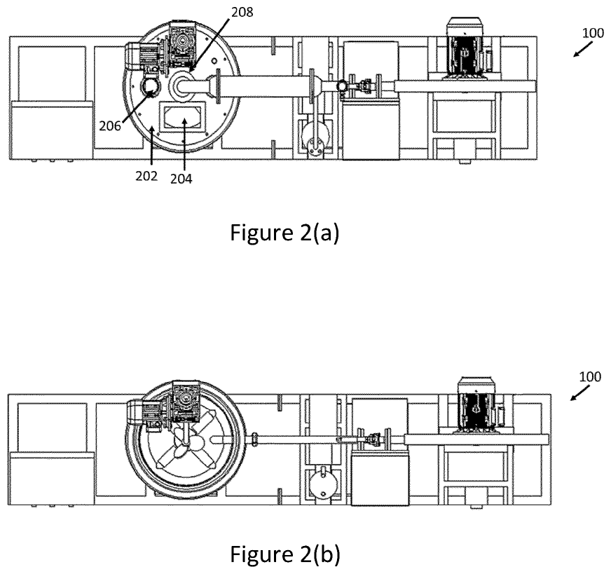

FIG. 2(a) illustrates a top view of the aeration assembly 100 with closed top 110 in accordance with an embodiment of the present invention. Further, FIG. 2(b) illustrates another top view of the aeration assembly 100 with open top in accordance with an embodiment of the present invention. For the sake of brevity FIGS. 2(a) and 2(b) have been described together.

The aeration tank 102 may have a closed top 110, such that the top surface of the aeration tank 102 may be covered by a lid 202, as illustrated in FIG. 2(a). In an embodiment of the present invention, the lid 202 may be removable to open top of the aeration tank 102. Further, the lid 202 of the aeration tank 102 may include a lipid refill aperture 204, viewing windows 206, temperature sensors and a slot 208 to attach the condenser column 120 of the exhaust device 106 with the aeration tank 102. The lipid refill aperture 204 may enable refilling of lipid into the aeration tank 102 for activation via aeration. Further, the viewing windows 206 may be used by an operator or technician for visual inspection of the aeration tank 102.

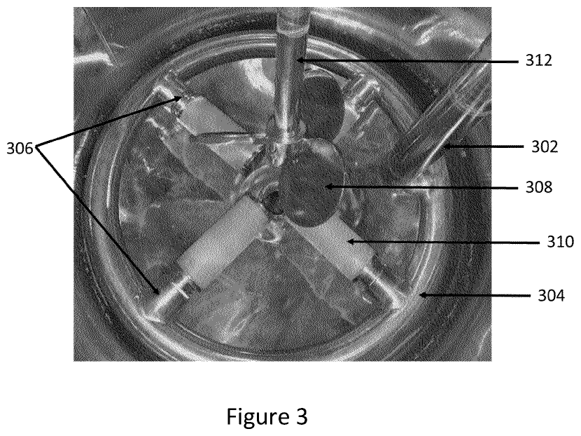

FIG. 3 illustrates an isometric view of an inlet conduit 302, a ring conduit 304, a micronization assembly 306 and a propeller type impeller 308 in the aeration tank 102 in accordance with an embodiment of the present invention.

In an embodiment of the present invention, the inlet conduit 302 may be configured to allow passage of air for aeration of the lipid to the ring conduit 304 in the aeration tank 102. The opening for entry of the inlet conduit 302 may be formed on the cylindrical body of the aeration tank 102. Further, the ring conduit 304 may be arranged along inner circumference of bottom of the aeration tank 102.

In an embodiment of the present invention, the micronization assembly 306 may include one or more spargers 310. Further, the micronization assembly 306 may be radially attached to the ring conduit 304. The spargers 310 of the micronization assembly 306 may be arranged in form of spokes of a wheel, where the ring conduit 304 may be understood as the wheel. The micronization assembly 306 may be configured to receive air from the ring conduit 304 and to micronize the received air by passing the received air through the one or more spargers 310.

Further, the propeller type impeller 308 may be arranged axially above the sparger assembly to agitate the lipid in the aeration tank 102 to facilitate contact between the micronized air and the lipid for aeration of the lipid to obtain aerated lipid. The propeller type impeller 308 may have a shaft 312 attached to a motor for controlling the rotation of the propeller type impeller 308. The motor may be placed on the lid 202 of the aeration tank 102 and may be controlled by the control unit 108.

To achieve optimum aeration assembly 100 configuration and desired lipid activation, various impeller blade designs were considered during experimentation. It was observed the axial blade design caused inadequate lipid-air circulation. Further, cutter blade design allowed faster mixing of lipid-air compared to the axial blade design. However, due to the cutter blade design bigger size air bubbles were generated which impacted the generation of fried markers. Further, based on the design of base of the aeration tank 102, which is a U-trough design and the arrangement of micronizers, propeller type impeller 308 provided optimum agitation for desired aeration of the lipid.

In conventional air stripping units used in effluent treatment plants, drilled tubes are used to generate air bubbles of size ranging from 10 to 20 mm. When the similar structure was implemented in the present invention, it was observed that the air bubbles were short-lived which rapidly moved upward and coalesce. The short life and coalesce of the air bubbles prevented the effective mixing and exposure of the lipids to the air and consequently lead to inefficient oxidation or aeration of lipids, in addition to excessive generation of fumes. The micronization of the air by the spargers 310 and the agitation by the propeller type impeller 308 in the present invention facilitated lipid activation in shorter treatment time of 2 to 10 hours with improved heat and mass transfer efficiency, such that the activated lipid comprises a TPM between 6.5 to 20%. In an exemplary embodiment of the present invention, the TPM range of 12-15% may be preferable for 4-6 hours of treatment.

The present invention will now be discussed with respect to its operation. In operation, non-activated lipid may be filled in the aeration tank 102 through the lipid refill aperture 204. In an exemplary embodiment of the present invention, a level sensor or a weight sensor may be employed in the aeration tank 102 to measure the amount of lipid in the aeration tank 102. When the amount of lipid in the aeration tank 102 may reach to the threshold level, the microcontroller may stop the filling of the lipid in the aeration tank 102. The threshold level of the lipid may be such that the micronization assembly is completely submerged in the lipid to be activated.

Upon completion of filling of lipid in the aeration tank 102, the operation of the aeration assembly 100 may be initiated, whereby the centrifugal blower 118 may pull-in atmospheric air from ambient environment of the aeration assembly 100 and may be passed to the inlet conduit 302. The predefined flow rate air in the inlet conduit 302 may be in a range of 0.5-8 Litres per hour per gram, more preferably between 4 to 8 Litres per hour per gram of lipid (L/h/g) for an aeration time between 2 to 10 hours. In an exemplary embodiment of the present invention, compressed air from the compressed air source may be combined with atmospheric air from the centrifugal blower 118 and the combined air may be passed to the inlet conduit 302. Further, the heating element 132 on the outer circumference of the aeration tank 102 may start heating the lipid to a predefined temperature via indirect or non-contact heating. The predefined temperature may be between 100-180° C. for an aeration time between 2 to 10 hours.

The inlet conduit 302 may allow the passage of air inside the aeration tank 102 with the lipid. Further, the air from the inlet conduit 302 may be passed to the ring conduit 304, which may then pass the air to the micronization assembly 306. The spargers 310 of the micronization assembly 306 may micronize the air bubbles and discharge them into the lipid in the aeration tank 102. The process of micronization increases the contact surface area of the air and the lipid.

Next, the propeller type impeller 308 under the impact of the motor may start rotating about the shaft 312 amounting to generation of a lipid vortex in the aeration tank 102 and agitation of the lipid. The agitation may facilitate contact between the micronized air and the lipid for aeration of the lipid to obtain aerated and activated lipid. Further, the activated lipid may be collected from the aeration tank 102 via the collection device.

Further, the by-products of the aeration may be in form of fumes and may be passed through the condenser column 120 and the horizontal heat exchanger 122. The by-products may be condensed and cooled down in the condenser column 120 and the horizontal heat exchanger 122. Further, the gaseous exhaust outlet 128 may vent out gaseous by-products. Furthermore, the scrubber apparatus 124 may receive the condensed by-products for treatment, such that the condensed by-products treated by the scrubber apparatus 124 are neutralized before expelling from the aeration assembly 100.

The above elaborated configuration of the aeration assembly 100 and the operating conditions for the activation of the lipid via oxidation to generate the desired flavor profile were achieved via experimentation. The experimental data for some of the scenarios with alternate configuration of the aeration assembly 100 and different operating conditions has been provided below to indicate the technical advance of the present invention.

| Operating | Minimum | Maximum | |
|---|---|---|---|
| condition | value | value | Aeration outcome |
| Heating time | 2 hours | 10 hours | The intensity of |
| or lipid | | | fried marker |
| activation | | | compound (E, E-2,4- |
| time | | | Decadienal) was |
| | | | increased from 2 to |
| | | | 10 hours with |
| | | | optimum generation |
| | | | between 4-5 hours |
| | | | of lipid activation |
| | | | or oxidation. The |
| | | | process end-point |
| | | | indicator which is |
| | | | total polar matter |
| | | | stayed between 12- |
| | | | 15% which fits |
| | | | within maximum |
| | | | discard limits of |
| | | | frying oil (25%). |
| | | | Lesser heating (<2 |
| | | | hour) produced |
| | | | inadequate fried |
| | | | intensity while |
| | | | heating beyond 6 |
| | | | hour caused |
| | | | rancidity generation |
| | | | (hexanal formation) |
| | | | and overshooting of |
| | | | total polar matter |
| | | | over 20%. |
| Heating | 100 | 180 | The intensity of |
| temperature | Degree C. | Degree C. | fried marker |
| or lipid | | | compound (E, E-2,4- |
| activation | | | Decadienal) was |
| temperature | | | increased from 100 |
| | | | to 160° C. with |
| | | | optimum generation |
| | | | between 140-150° C. |
| | | | of lipid activation |
| | | | or oxidation. Lesser |
| | | | temperatures (<100° |
| | | | C.) took longer time |
| | | | to produce fried |
| | | | intensity which is |
| | | | operationally |
| | | | inefficient while |
| | | | greater temperature |
| | | | (>180° C.) |
| | | | caused |
| | | | excessive foaming |
| | | | and fuming or |
| | | | smoking of lipids, |
| | | | in addition to |
| | | | rancidity generation |
| | | | (hexanal formation) |
| | | | and overshooting of |
| | | | total polar matter |
| | | | over 20%. The |
| | | | desired fried |
| | | | intensity is not |
| | | | achieved at such low |
| | | | and high temperature - |
| | | | time combinations |
| Air flow | 0.5 | 8.0 | Optimal range was |
| rate | Liters | Liters | 0.5-8 Litres per |
| | per hour | per hour | hour per gram, more |
| | per gram | per gram | preferably between 4 |
| | of lipid | of lipid | to 8 Litres per hour |
| | | | per gram of lipid. |
| | | | Higher values caused |
| | | | excessive foaming |
| | | | and splashing of |
| | | | lipids and |
| | | | generation of fumes |
| | | | and smokes. Lower |
| | | | values caused low |
| | | | rate of lipid |
| | | | activation which was |
| | | | insufficient to |
| | | | produce desired |
| | | | levels of fried |
| | | | intensity. |

### Table 1

Table 1 illustrated above indicates results of aeration of lipid in operating conditions different from the one implemented in the present invention i.e., aeration of the lipid at a temperature between 100-180° C. and at a flow rate of air in a range of 0.5-8 Litres per hour per gram, more preferably between 4 to 8 Litres per hour per gram of lipid (L/h/g) for an aeration time between 2 to 10 hours.

### Experimental Configuration 1 of the Aeration Assembly

Experimental configuration 1 of the aeration assembly included an open top aeration tank for lipid activation. The temperature of the lipid was between 140-150 Degree C. and airflow rate was in the range of 4-8 Liters per hour per gram of lipid. Further, provision of air inlet was near mid-bottom of aeration tank side wall. In the experimental configuration 1 of the aeration assembly, inadequate negation of air bubbles with bigger size air bubbles i.e., about 20-40 mm were generated causing ineffective circulation and mixing of lipid and air. Further, it had slower rate of activation of lipids, inadequate generation of desired fried markers and hence, low intensity of fried aroma in activated lipid. Thus, desired TPM of 12-15% was not reached. Additionally, the experimental configuration 1 suffered from non-uniform distribution of fried markers from different collection points due to poor agitation. Further, lipid activation time was more than 8 hours, and it was energy intensive process.

### Experimental Configuration 2 of the Aeration Assembly

Experimental configuration 2 of the aeration assembly included a larger and open aeration tank equipped with air bubble generating units placed between the heating elements, alternate and adjacent to each other. The lipid was heated to temperature in range of 140-150° C. and airflow rate was 8 Liters per hour per gram of lipid. In the experimental configuration 2 of the aeration assembly no agitation system was used, hence lipid was circulated through a pump for uniformity. Thus, in the experimental configuration 2 of the aeration assembly bigger size of air bubbles were generated with non-uniform size ranging between 10-50 mm, high turbulence and splashing on surface causing heavy fumes and smoke.

Further, in the experimental configuration 2 of the aeration assembly adequate generation of fried markers and TPM of at least 12% was achieved. However, the fried intensity in activated lipid was not homogenous. Lipid samples collected near heating surface and vessel top had higher markers than those in middle layer indicating ineffective mixing of lipid-air. Further, the operation was not feasible due to generation of high amount of fumes. The activation time for the experimental configuration 2 of the aeration assembly was between 5-8 hours.

### Subsequent Experimental Configurations 3 and 4 of the Aeration Assembly

The experimental configurations 3 and 4 of the aeration assembly had a close top aeration tank with operating temperature between 100-180° C., preferably 140-150° C., and airflow rate between 0-8 Liters per hour per gram of lipid, preferably 4-8 Liters per hour per gram of lipid. Further, the aeration tank in both had multiple heating elements immersed into lipid and turbulence was created using an impeller system having multiple blade designs.

Further, the base of aeration tank was experimented from flat base to curve with air spargers arranged in parallel and finally to U-shaped bottom trough design. This ensured effective circulation and mixing of lipid-air bubbles, minimizing localized hot spots. The sparger assembly was attached to blower designed for volume high under low pressure requirements. Also, an arrangement was provided to combine the air from blower 118 and an external source of compressed air for effective air volume and pressure combination.

The previously faced challenges on air bubble sizing and its uniform mixing with lipid was overcome by use of the micronizing spargers and air bubble size ranging between 10-50 microns was achieved. The achieved air bubble size helped the air bubbles to be limited between 50 to 100 microns and enhances the availability for appropriate interaction with the lipid.

However, in experimental configurations 3 and 4, the heating element was placed in direct contact with lipid, thus created a skin effect on heating surface amounting to poor heat transfer which minimized the circulation of aerated lipid. This leads to non-homogenous distribution leading to inadequate fried intensity in activated lipid.

To circumvent this in the present invention, the heating element 132 was moved out with an indirect contact through plate heating system mounted on outer surface of aeration tank 102. This eventually helped to achieve better heat transfer homogeneity, effective circulation of aerated lipid, and consequently reaching the desired endpoint with adequate generation of fried markers. The use of propeller type impeller 308 ensured the effective lipid recirculation along the inner surface of reaction vessel to prevent any skin effect.

In order to prevent overheating of lipid that gets accelerated with micronized air bubbles, a dual set of temperature controllers have been incorporated in the present invention.

As may be observed from the experimental data and detailed provided description above, the configuration of the aeration assembly 100 and the predefined operating conditions for lipid activation of the present invention provides the following effects or advantages:
Faster rate of lipid activation;
Adequate generation of fried markers due to effective circulation and mixing of lipid-air bubbles;
Air bubbles size between 50 to 100 microns.
The end-point of lipid activation i.e. TPM: 6.5-20% was reached in between 2-10 hours, more preferably 12-15% was reached between 4-5 hours

The continuous supply of the atmospheric air for the aeration of the lipid by the centrifugal blower 118 provides a balanced and continuous air flow for the activation of the lipid. Further, the source of compressed air provides a mechanism to prevent blockage of spargers 310 due formation of lipid layer on them. The prevention of blockage circumvents the maintenance downtime and inefficient activation if the process is stopped before complete activation, making the aeration of lipid faster and more efficient.

Further, the closed top 110 of the aeration tank 102 with the exhaust device 124 as the neutralizer and the outlet of by-products, prevents splashing of the lipid while aeration. Also, as the by-products with pungent smell and irritants is not released in the ambient environment, the operator may operate the aeration assembly for a long time at a stretch without any health complications. Thus, the process of activation of lipid via aeration may be carried out for longer time durations and continuously. Further, as the by-products are not released in the ambient environment as it is, the atmospheric air in the premise remains non-impacted and thus a constant quality of air may be supplied to the aeration tank 102, making the activation homogenous and efficient.

Additionally, the arrangement of the micronizing assembly 306 and the ring conduit 304 in form of spokes of the wheel and the wheel, ensures that the air is provided along complete area of the aeration tank to avoid formation of localized zones with higher air ingress. Also, the micronizing assembly 306 provides air bubbles of small size to increase contact surface area and better interaction between the lipid and the air for faster, homogenous and efficient activation of the lipid. Further, the propeller type impeller 308 and the curved base 112 of the aeration tank 102, provide requisite agitation to the lipid to ensure faster and efficient contact between the micronized air bubbles.

Thus, the configuration of the aeration assembly 100 and the operating conditions provide desired environment for faster, efficient and homogenous activation of lipid and generation of desired flavors in the activated lipid.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1-11. (canceled)

12. An aeration assembly comprising:
an aeration tank configured to receive a lipid, the aeration tank comprising:
a closed top;
a curved base;
an inlet conduit to allow passage of air for aeration of the lipid to a ring conduit in the aeration tank, the ring conduit being arranged along an inner circumference of a bottom of the aeration tank; and
a micronization assembly radially attached to the ring conduit, the micronization assembly having a sparger and being configured to receive air from the ring conduit and micronize the received air via the sparger; and
an impeller disposed axially above the sparger and configured to agitate the lipid received in the aeration tank such that the micronized air contacts the lipid to generate an aerated lipid.

13. The aeration assembly of claim 12, further comprising an air supply device (configured to:
receive atmospheric air pulled in by a centrifugal blower;
receive compressed air from a compressed air source;
combine the received atmospheric air with the received compressed air to control a pressure and a flow rate of the combined air; and
supply the combined air to the inlet conduit of the aeration tank.

14. The aeration assembly of claim 12, further comprising a temperature control device having a temperature sensor and a heating element;
wherein the temperature sensor is configured to generate an output indicative of a temperature of the lipid in the aeration tank and the heating element is configured to adjust the temperature of the lipid in the aeration tank based upon the output of the temperature sensor.

15. The aeration assembly of claim 14, wherein the temperature sensor is disposed inside the aeration tank and the heating element is disposed on an outer surface of the aeration tank such that heat generated by the heating element is transferred to the lipid via conduction through a wall of the aeration tank.

16. The aeration assembly of claim 12, further comprising an exhaust device configured to vent gaseous by-products created by the generation of the aerated lipid.

17. The aeration assembly of claim 16, wherein the exhaust device includes a condenser column configured to receive and condense gaseous by-products created by the generation of the aerated lipid before venting of the gaseous by-products.

18. The aeration assembly of claim 17, wherein the exhaust device includes a horizontal heat exchanger coupled to the condenser column and configured to receive, condense, and cool gaseous by-products from the condenser column

19. The aeration assembly of claim 18, wherein the exhaust device includes a gaseous exhaust outlet coupled to the horizontal heat exchanger and configured to vent out gaseous by-products.

20. The aeration assembly of claim 19, wherein the exhaust device includes a scrubber apparatus coupled to the horizontal heat exchanger and configured to receive and treat gaseous by-products received from the horizontal heat exchanger such that the gaseous by-products treated are neutralized.

21. The aeration assembly of claim 19, wherein the scrubber apparatus is a water scrubbing apparatus.

22. The aeration assembly of claim 12, wherein the lipid is aerated between 100 and 180 degree centigrade for a period between 2 and 10 hours.

23. The aeration assembly of claim 12, wherein the lipid is aerated at an air flow rate between 0.5 and 8 Litres per hour per gram of lipid.

24. The aeration assembly of claim 23, wherein the lipid is aerated for a period between 2 and 10 hours.

25. The aeration assembly of claim 12, wherein the lipid is aerated at an air flow rate between 4 and 8 Litres per hour per gram of lipid.

26. The aeration assembly of claim 25, wherein the lipid is aerated for a period between 2 and 10 hours.

27. The aeration assembly of claim 12, further comprising a collection device disposed at a bottom of the aeration tank and having a collection conduit and a collection valve configured to collect the aerated lipid from the aeration tank.

28. The aeration assembly of claim 12, wherein the aerated lipid has a Total Polar Matter (TPM) between 6.5% and 20%.

29. The aeration assembly of claim 12, wherein the aerated lipid has a Total Polar Matter (TPM) between 12% and 15%.

30. The aeration assembly of claim 12, wherein bubbles of the micronized air have a size less than 100 microns.

31. The aeration assembly of claim 12, where bubbles of the micronized air have a size between 50 microns and 100 microns.
